(19) United States
(12) Patent Application Publication
(10) Pub. No.: US 2013/0036795 A1
(43) Pub. Date: Feb. 14, 2013

(54) GAS SENSOR

(71) Applicants: Naoki YAMADA, Iwakura-shi (JP); Takayoshi ATSUMI, Konan-shi (JP); Hideya INUKAI, Ogaki-shi (JP); Takeo MIZUI, Konan-shi (JP); Yoshiyasu FUJII, Nagoya-shi (JP)

(72) Inventors: Naoki YAMADA, Iwakura-shi (JP); Takayoshi ATSUMI, Konan-shi (JP); Hideya INUKAI, Ogaki-shi (JP); Takeo MIZUI, Konan-shi (JP); Yoshiyasu FUJII, Nagoya-shi (JP)

(73) Assignee: NGK SPARK PLUG CO., LTD., Nagoya-shi (JP)

(21) Appl. No.: 13/205,542

(22) Filed: Aug. 8, 2011

(51) Int. Cl. G01N 27/00

(52) U.S. Cl. 73/31.05

(57) ABSTRACT

[Objective] To provide a gas sensor in which a filter member provided in an aerial communication hole adapted to introduce the air for exposing a reference electrode of a detection element to the air is reliably protected through simple configuration.

[Means for Solution] A filter member 87 having air permeability and waterproofness is disposed in an aerial communication hole 91 formed in a grommet 9 disposed in a rear end portion 38 of a housing tube 3. The housing tube 3 has a vent portion 34 provided for ensuring aerial communication while protecting the filter member 87. The vent portion 34 is connected, by means of arm portions 33, to an end portion (an opening end 32) of a side wall 39 of the housing tube 3. The side wall 39 surrounds the circumference of the grommet 9. Since the arm portions 33 are disposed in respective grooves 93 of the grommet 9, the grommet 9 is positioned relative to the housing tube 3. Thus, the vent portion 34 formed integral with the housing tube 3 is free from offset, inclination, torsion, etc., relative to the aerial communication hole 91.

### TECHNICAL FIELD

The present invention relates to a gas sensor having an aerial communication structure for exposing, to the air, a reference electrode of a detection element for detecting a particular gas.

### BACKGROUND ART

A conventionally known gas sensor has a detection element which uses a solid electrolyte body made of ceramic, such as zirconia, and is adapted to detect a particular gas component (e.g., oxygen) in exhaust gas emitted from an internal combustion engine. For example, a detection element of an oxygen sensor for detecting oxygen has the following configuration: a detection electrode to be exposed to exhaust gas and a reference electrode to be exposed to a reference gas (usually, the air) are paired with each other and formed on respective opposite surfaces of the solid electrolyte body in such a manner that the solid electrolyte body is sandwiched therebetween. The detection element detects oxygen contained in exhaust gas on the basis of electromotive force which is generated between the two electrodes according to the difference in partial pressure of oxygen between the two atmospheres separated from each other by the solid electrolyte body; i.e., between the exhaust gas and the reference gas (the air).

The detection element is held in a metallic shell. When the metallic shell is mounted to an exhaust pipe of the internal combustion engine, the detection electrode (detection portion) provided at a front end portion of the detection element is exposed to exhaust gas which flows through the exhaust pipe. A rear end portion of the detection element projects rearward from the metallic shell and is surrounded by a housing tube joined to the metallic shell. The reference electrode of the detection element is in contact with an atmosphere within the housing tube. The atmosphere within the housing tube and an atmosphere around the detection electrode are separated from each other by the metallic shell. Lead wires for leading out detection signals from the detection element extend outward from the housing tube. A lead wire outlet of the housing tube is plugged with a plug member. The plug member (grommet) has lead wire insertion holes for allowing the respective lead wires (sensor output lead wires and heater lead wires) to extend therethrough, as well as an aerial communication hole (through hole) for establishing aerial communication between the inside and the outside of the housing tube in order to introduce the air toward the reference electrode. A filter member is provided in the areal communication hole in order to prevent entry of water droplets, etc., into the housing tube while allowing entry of the air into the housing tube (refer to, for example, Patent Document 1).

### PRIOR ART DOCUMENT

### Patent Document

[Patent Document 1] Japanese Patent Application Laid-Open (kokai) No. 2006-208165

### SUMMARY OF THE INVENTION

### Problems to be Solved by the Invention

However, in the oxygen sensor of Patent Document 1, the filter member is exposed directly to the outside of the sensor. Usually, the oxygen sensor is disposed at such a portion of an automobile as to be located near the road surface. Accordingly, the filter member may directly receive an external impact stemming from contact with plants or impingement of a flipped stone or the like, potentially resulting in damage to the filter member. In order to protect the filter member, it is good practice to provide a protection member for protecting the filter member in such a manner as to cover the aerial communication hole from the rear side of the filter member. However, since, as mentioned above, the lead wires extend outward from the plug member, the protection member must be provided in such a manner as not to damage the lead wires. Furthermore, in order to facilitate assembling work in the course of manufacture of the oxygen sensor, desirably, a protection member having a structure that allows noncontact with the lead wires is assembled to the housing tube at the final step of the manufacturing procedure. However, this practice may involve a failure to reliably protect the filter member with the protection member due to an inclined assembly of the protection member to the housing tube or the generation of play of the protection member assembled to the housing tube.

The present invention has been conceived to solve the above-mentioned problem, and an object of the invention is to provide a gas sensor in which the filter member provided in the aerial communication hole adapted to introduce the air for exposing the reference electrode of the detection element to the air is reliably protected through a simple configuration.

### Means for Solving the Problems

A gas sensor according to a first mode of the present invention comprises a detection element extending in a direction of an axis and having a detection portion located at its front end for detecting a particular gas; a metallic shell allowing the detection portion to project from its front end and surrounding the circumference of the detection element; a housing tube surrounding the circumference of a rear end portion of the detection element and fixed, at its front end portion, to the metallic shell; and a plug member disposed in a rear end portion of the housing tube and having lead wire insertion holes which are formed therein in such a manner as to extend in the direction of the axis and through which respective lead wires extend for leading out detection signals from the detection element, and an aerial communication hole which is formed therein in such a manner as to extend in the direction of the axis and which can establish aerial communication between the inside and the outside of the housing tube via an intervening filter member having air permeability and waterproofness. The gas sensor is characterized in that the'housing tube has a side portion surrounding the circumference of the plug member; a vent portion disposed rearward of the plug member, covering the aerial communication hole of the plug member, and having an opening smaller than at least an opening of the aerial communication hole; and a strip-like arm portion extending radially and connecting the side portion and the vent portion to each other.

In the gas sensor according to the first mode, the vent portion of the housing tube covers the aerial communication hole of the plug member, thereby preventing outward exposure of the filter member disposed (lying in an intervening manner) in the aerial communication hole and protecting the filter member from an external impact stemming from contact with plants or impingement of a flipped stone or the like. Also, the opening of the vent portion can ensure aerial communication between the outside of the housing tube and the inside of the aerial communication hole. Furthermore, since a connecting structure between the vent portion and the side portion assumes the form of the strip-like arm portion, the arm portion and the lead wires can be spaced apart from each other, thereby preventing interference between the arm portion and the lead wires.

Meanwhile, the vent portion and the housing tube's side portion surrounding the circumference of the plug member are connected together by means of the arm portion. That is, the arm portion and the vent portion are formed integral with the housing tube; i.e., the arm portion and the vent portion are configured collectively as a portion of the housing tube. Thus, in the course of manufacture of the gas sensor, by merely fixing the housing tube to the metallic shell, the arm portion and the vent portion can also be fixed to the metallic shell. This eliminates a problem arising in the case where the housing tube and the vent portion are formed as separate members; specifically, a problem of an inclined assembly of the vent portion to the housing tube or a problem of generation of play of the vent portion assembled to the housing tube. Therefore, the vent portion can reliably protect the filter member.

Furthermore, in the case where the housing tube is formed separately from the vent portion and the arm portion, assembling work involves the following two steps: a step of fixing the housing tube to the metallic shell, and a step of fixing the arm portion and the vent portion to the housing tube. By contrast, according to the present invention, work of these steps can be done in a single step, whereby the number of man-hours can be reduced. Also, the integration of the housing tube, the arm portion, and the vent portion into a single member eliminates the need to provide a structure of mutual fixation, thereby not only reducing the number of components, but also simplifying the structure.

In the gas sensor according to the first mode, the plug member may have, on its rear end surface, a groove starting from the aerial communication hole and extending radially outward in such a manner as to avoid the lead wire insertion holes. In this case, it is good practice to dispose the arm portion in the groove. In this manner, by means of the arm portion being disposed in the groove provided in such a manner as to avoid the lead wire insertion holes, the interference of the arm portion with the lead wires can be reliably avoided. Since the arm portion and the groove are positioned relative to each other, circumferential rotation of the plug member relative to the housing tube can be prevented; thus, the contact between the arm portion and the lead wires can be prevented. Furthermore, the lead wires do not come into contact with the vent portion and the housing tube which are integral with the arm portion, whereby the lead wires can be reliably protected from damage which could otherwise result from contact with other members.

In the gas sensor according to the first mode, the housing tube may have at least two pieces of the arm portion, and the plug member may have at least two pieces of the groove. In this case, it is good practice to dispose the arm portions in the respective grooves. By virtue of a plurality of the arm portions being disposed in the respective grooves, even when torsion about a certain arm portion is applied to the vent portion, another arm portion is in contact with the associated groove, thereby restraining the torsion. Thus, in disposition of the vent portion relative to the aerial communication hole, the vent portion can be free from inclination, offset, etc.

In the gas sensor according to the first mode, the vent portion may assume a form in which a plurality of holes are formed therein in such a manner as to extend therethrough in the direction of the axis, a form in which a mesh member is attached to an opening thereof oriented in the direction of the axis, or a form in which a protrusion formed thereon has an opening formed in its side. Desirably, the vent portion has such a structure as to not only protect the filter member by covering the filter member from outside, but also maintain sufficient aerial communication between the inside and the outside of the housing tube. Through employment of such a simple structure that the vent portion has a plurality of holes formed therein in such a manner as to extend therethrough in the direction of the axis, the filter member can be protected, and aerial communication can be ensured. Similarly, through employment of such a simple structure that the mesh member is attached to the vent portion or such a simple structure that the vent portion has a protrusion having an opening formed in its side for enabling aerial communication, the filter member can be protected, and aerial communication can be ensured.

A gas sensor according to a second mode of the present invention comprises a detection element extending in a direction of an axis and having a detection portion located at its front end for detecting a particular gas; a metallic shell allowing the detection portion to project from its front end and surrounding the circumference of the detection element; a housing tube surrounding the circumference of a rear end portion of the detection element and fixed, at its front end portion, to the metallic shell; and a plug member disposed in a rear end portion of the housing tube and having lead wire insertion holes which are formed therein in such a manner as to extend in the direction of the axis and through which respective lead wires extend for leading out detection signals from the detection element, and an aerial communication hole which is formed therein in such a manner as to extend in the direction of the axis and can establish aerial communication between the inside and the outside of the housing tube via an intervening filter member having air permeability and waterproofness. The gas sensor is characterized in that the housing tube has a side portion surrounding the circumference of the plug member; a cover portion which covers the filter member in such a manner that, as viewed from a rear side of the gas sensor in the direction of the axis, the filter member is invisible and which allows aerial communication between the inside of the aerial communication hole and the outside of the housing tube via a gap between the cover portion and the plug member; and a strip-like arm portion extending radially and connecting the side portion and the cover portion to each other.

In the gas sensor according to the second mode, the cover portion of the housing tube covers the aerial communication hole of the plug member, thereby preventing outward exposure of the filter member disposed (lying in an intervening manner) in the aerial communication hole and protecting the filter member from an external impact stemming from contact with plants or impingement of a flipped stone or the like. Also, the gap between the cover portion and the plug member can ensure aerial communication between the outside of the housing tube and the inside of the aerial communication hole. Furthermore, since a connecting structure between the cover portion and the side portion assumes the form of the strip-like arm portion, the arm portion and the lead wires can be spaced apart from each other, thereby preventing interference between the arm portion and the lead wires.

Meanwhile, the cover portion and the housing tube's side portion surrounding the circumference of the plug member are connected together by means of the arm portion. That is, the arm portion and the cover portion are formed integral with the housing tube; i.e., the arm portion and the cover portion are configured collectively as a portion of the housing tube. Thus, in the course of manufacture of the gas sensor, by merely fixing the housing tube to the metallic shell, the arm portion and the cover portion can also be fixed to the metallic shell. This eliminates a problem arising in the case where the housing tube and the cover portion are formed as separate members; specifically, a problem of an inclined assembly of the cover portion to the housing tube or a problem of generation of play of the cover portion assembled to the housing tube. Therefore, the cover portion can reliably protect the filter member.

Furthermore, in the case where the housing tube is formed separately from the cover portion and the arm portion, assembling work involves the following two steps: a step of fixing the housing tube to the metallic shell, and a step of fixing the arm portion and the cover portion to the housing tube. By contrast, according to the present invention, work of these steps can be done in a single step, whereby the number of man-hours can be reduced. Also, the integration of the housing tube, the arm portion, and the cover portion into a single member eliminates the need to provide a structure of mutual fixation, thereby not only reducing the number of components, but also simplifying the structure.

In the gas sensor according to the second mode, the plug member may have, on its rear end surface, a groove starting from the aerial communication hole and extending radially outward in such a manner as to avoid the lead wire insertion holes. In this case, it is good practice to dispose the arm portion in the groove. In this manner, by means of the arm portion being disposed in the groove provided in such a manner as to avoid the lead wire insertion holes, the interference of the arm portion with the lead wires can be reliably avoided. Since the arm portion and the groove are positioned relative to each other, circumferential rotation of the plug member relative to the housing tube can be prevented; thus, the contact between the arm portion and the lead wires can be prevented. Furthermore, the lead wires do not come into contact with the cover portion and the housing tube which are integral with the arm portion, whereby the lead wires can be reliably protected from damage which could otherwise result from contact with other members.

In the gas sensor according to the second mode, the housing tube may have at least two pieces of the arm portion, and the plug member may have at least two pieces of the groove. In this case, it is good practice to dispose the arm portions in the respective grooves. By virtue of a plurality of the arm portions being disposed in the respective grooves, even when torsion about a certain arm portion is applied to the cover portion, another arm portion is in contact with the associated groove, thereby restraining the torsion. Thus, in disposition of the cover portion relative to the aerial communication hole, the cover portion can be free from inclination, offset, torsion, etc.

### BRIEF DESCRIPTION OF THE DRAWINGS

FIG. 1 Vertical sectional view showing the structure of a gas sensor 1 according to a first embodiment of the present invention.

FIG. 2 Perspective view showing a grommet 9 before attachment.

FIG. 3 View showing the gas sensor 1 as viewed from the rear side (upper side in FIG. 1) with respect to the direction of an axis O.

FIG. 4 Perspective view showing a housing tube 3 before attachment.

FIGS. 5A to 5D Views showing an example process for manufacturing a rear assembly of a gas sensor.

FIG. 6 Perspective view showing the shape of a rear end portion of a modified housing tube 110.

FIG. 7 Perspective view showing the shape of a rear end portion of a modified housing tube 120.

FIG. 8 Perspective view showing the shape of a rear end portion of a modified housing tube 130.

FIG. 9 Perspective view showing the shape of a rear end portion of a modified housing tube 140.

FIG. 10 Vertical sectional view showing the structure of a gas sensor 201 according to a second embodiment of the present invention.

FIG. 11 View showing the gas sensor 201 as viewed from the rear side (upper side in FIG. 10) with respect to the direction of the axis O.

### MODES FOR CARRYING OUT THE INVENTION

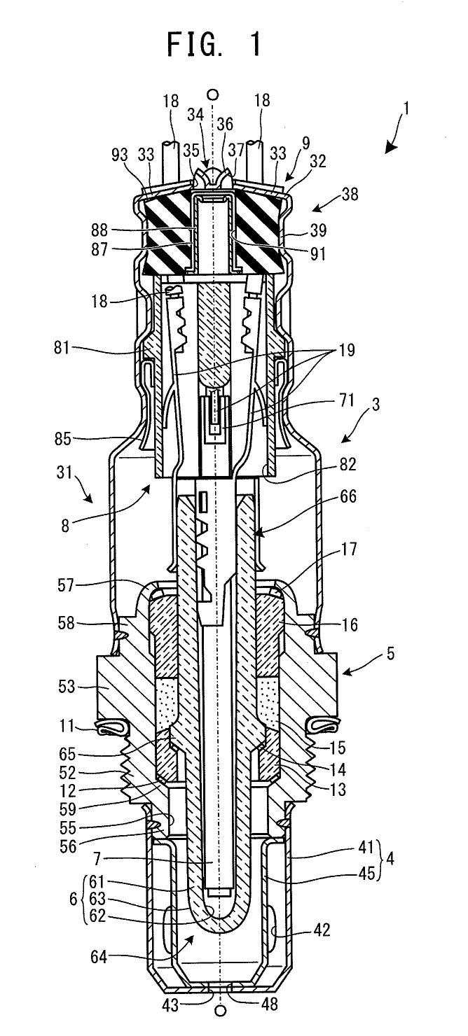

A gas sensor according to an embodiment of the present invention will next be described with reference to the drawings. First, the structure of a gas sensor 1 according to a first embodiment of the present invention is described with reference to FIGS. 1 to 4. The gas sensor 1 shown in FIG. 1 is mounted to an exhaust pipe (not shown) for exhaust gas emitted from an internal combustion engine of an automobile or the like. In the following description, a side directed, along the direction of an axis O of the gas sensor 1, toward the distal end of a detection element 6 to be inserted into the exhaust pipe (a side toward the closed end of the detection element 6; i.e., the lower side in FIG. 1) is referred to as the front side, and the opposite side (the upper side in FIG. 1) as the rear side.

The gas sensor 1 shown in FIG. 1 is adapted to detect whether or not oxygen exists in exhaust gas flowing through the exhaust pipe. The gas sensor 1 has a structure in which the slender, tubular detection element 6 having a closed end is held within a metallic shell 5, a housing tube 3, and a protector 4. Lead wires 18 extend outward from the gas sensor 1 for leading out signals output from the detection element 6 and for supplying electricity to a heater 7 provided side by side with the detection element 6. The lead wires 18 are electrically connected to a sensor control unit or to an electronic control unit (ECU) of an automobile, the control units being unillustrated and provided at respective positions located away from the gas sensor 1.

The detection element 6 of the gas sensor 1 is configured such that a solid electrolyte body 61 serves as a base element. The solid electrolyte body 61 contains zirconia as a main component and has a closed-bottomed tubular shape extending in the direction of the axis O. A reference electrode 62 made of Pt or a Pt alloy is formed porously on the inner surface of the solid electrolyte body 61 in such a manner as to cover substantially the entire inner surface. Similar to the reference electrode 62, a detection electrode 63 made of Pt or a Pt alloy is formed porously on the outer surface of the solid electrolyte body 61. A front end portion (a closed end portion) of the detection element 6 serves as a detection portion 64. The detection electrode 63 formed on the outer surface of the detection portion 64 is exposed to exhaust gas which flows through the exhaust pipe (not shown). Although unillustrated, the detection electrode 63 is covered with a porous electrode protection layer made of heat-resistant ceramic, thereby being protected from poisoning by exhaust gas. The detection element 6 has a flange portion 65 projecting radially outward at substantially the middle position with respect to the direction of the axis O. A rodlike heater 7 is inserted into the closed-bottomed tube of the detection element 6 for activating the solid electrolyte body 61 through application of heat.

While being radially surrounded by the tubular metallic shell 5, the detection element 6 is held in a tubular hole 55 of the metallic shell 5. The metallic shell 5 is a tubular member made of stainless steel, such as SUS430. The metallic shell 5 has an externally threaded portion 52 formed at a frontward position. The externally threaded portion 52 is threadingly engaged with a mounting portion (not shown) of the exhaust pipe. The metallic shell 5 has, on its outer circumference, a front-end engagement portion 56 located frontward of the externally threaded portion 52. A protector 4, which will be described later, is externally engaged with the front-end engagement portion 56. The detection portion 64 of the detection element 6 projects frontward of the front-end engagement portion 56.

The metallic shell 5 has a tool engagement portion 53 located rearward of the externally threaded portion 52 and expanding radially outward. When the gas sensor 1 is to be mounted to the mounting portion (not shown) of the exhaust pipe, a mounting tool is engaged with the tool engagement portion 53. An annular gasket 11 is fitted to a portion of the metallic shell 5 located between the tool engagement portion 53 and the externally threaded portion 52 in order to prevent leakage of gas through the mounting portion of the exhaust pipe. The metallic shell 5 has, at its rear end, a crimp portion 57 for crimp-fixing the detection element 6 held in its tubular hole 55. A rear end portion 66 of the detection element 6 projects rearward of the crimp portion 57. The metallic shell 5 has, on its outer circumference, a rear-end engagement portion 58 located between the tool engagement portion 53 and the crimp portion 57. A front end portion 31 of the housing tube 3, which will be described later, is engaged with the rear-end engagement portion 58.

The metallic shell 5 internally has a stepped portion. 59 formed at a frontward position through radially inward projection of the inner circumferential surface of the tubular hole 55. A tubular support member 13 made of alumina is seated on the stepped portion 59 via a metal packing 12. The support member 13 also internally has a stepped portion formed through radially inward projection of its inner circumferential surface. The support member 13 supports the flange portion 65 of the detection element 6 via a metal packing 14 disposed on the stepped portion. Furthermore, a space located rearward of the support member 13 within the tubular hole 55 is filled with a filler 15 of a talc powder. A sleeve 16 made of alumina is disposed rearward of the filler 15 in such a manner that the filler 15 is sandwiched between the sleeve 16 and the support member 13.

An annular ring 17 is disposed rearward of the sleeve 16. When the crimp portion 57 of the metallic shell 5 is crimped radially inward and frontward, the sleeve 16 is pressed against the filler 15 via the ring 17. The crimping of the crimp portion 57 causes the filler 15 to compressively fill the associated space within the tubular hole 55 of the metallic shell 5 so as to press the flange portion 65 of the detection element 6 toward the support member 13 seated on the stepped portion 59 of the metallic shell 5, and also causes the filler 15 to fill the space between the inner circumferential surface of the tubular hole 55 and the outer circumferential surface of the detection element 6 in a gastight manner. In this manner, the detection element 6 is held in the tubular hole 55 of the metallic shell 5 via the members sandwiched between the crimp portion 57 and the stepped portion 59 of the metallic shell 5.

The protector 4 is welded to the front-end engagement portion 56 of the metallic shell 5 while covering the detection portion 64 of the detection element 6 which projects frontward from the front-end engagement portion 56 in the direction of the axis O. When the gas sensor 1 is mounted to the exhaust pipe (not shown), the protector 4 protects the detection portion 64 of the detection element 6 projecting into the exhaust pipe, from impingement of water droplets, foreign matter, etc., contained in exhaust gas. The protector 4 has a dual structure consisting of an outer protector 41 which has a closed-bottomed tubular shape and whose open end portion is joined to the front-end engagement portion 56, and an inner protector 45 having a closed-bottomed tubular shape and fixed within the outer protector 41. The outer protector 41 and the inner protector 45 have respective gas inlets 42 formed in their side walls for introducing exhaust gas thereinto so as to expose the detection portion 64 of the detection element 6 to exhaust gas (the gas inlet of the inner protector 45 is not shown). Also, the outer protector 41 and the inner protector 45 have outlets 43 and 48, respectively, formed in their bottoms, for discharging water droplets and exhaust gas from inside.

As mentioned above, the rear end portion 66 of the detection element 6 projects rearward of the rear end (the crimp portion 57) of the metallic shell 5. A tubular separator 8 made of an insulating ceramic is disposed rearward of the rear end portion 66 with respect to the direction of the axis O. The separator 8 has an accommodation portion 82 which accommodates four connection terminals 19 (FIG. 1 shows three of the connection terminals 19) independently of one another. The accommodation portion 82 extends through the separator 8 in the direction of the axis O and allows aerial communication between the front side and the rear side thereof. The connection terminals 19 are connected electrically and respectively to the reference electrode 62 of the detection element 6, the detection electrode 63, and a pair of electrodes 71 (FIG. 1 shows one of the electrodes 71) adapted to supply electricity to a heat-generating resistor of the heater 7 and exposed at a rear end portion of the heater 7. The separator 8 accommodates the connection terminals 19 in such a manner that the connection terminals 19 are separated from one another, thereby preventing mutual contact between the connection terminals 19. Conductors of the four lead wires (FIG. 1 shows two of the lead wires 18) are crimp-joined to the respective connection terminals 19. The lead wires 18 extend outward to the outside of the gas sensor 1 through a grommet 9, which will be described later. The separator 8 has a flange portion 81 projecting radially outward from its outer circumferential surface. A substantially cylindrical metal holder 85 is fitted to the outer circumferential surface of a portion of the separator 8 located frontward of the flange portion 81.

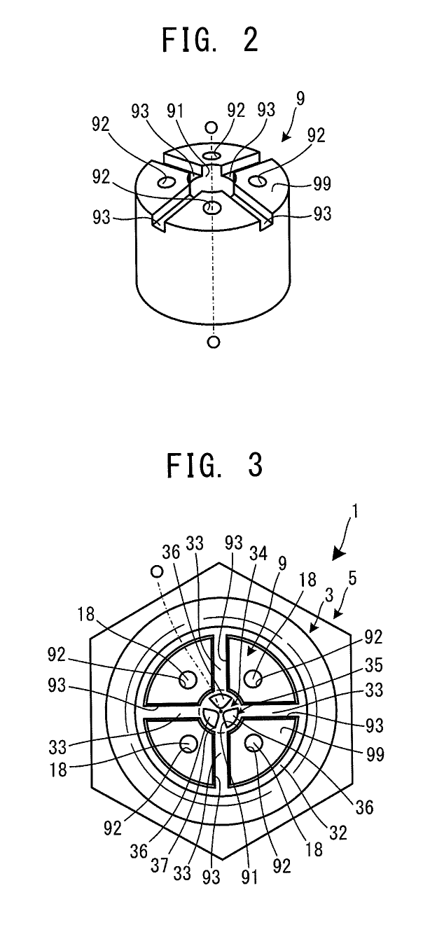

The grommet 9 made of fluororubber is disposed rearward of the separator 8. As shown in FIG. 2, the grommet 9 is a circular columnar member having a height along the direction of the axis O. The grommet 9 has an aerial communication hole 91 extending therethrough in the direction of the axis O and four lead wire insertion holes 92. The aerial communication hole 91 is formed at the radially center position of the grommet 9. The lead wire insertion holes 92 are formed around the aerial communication hole 91 at circumferentially equal intervals. As shown in FIG. 1, the aerial communication hole 91 is provided for introducing the air into the gas sensor 1 (into the housing tube 3, which will be described later) through the accommodation portion 82 of the separator 8. The detection element 6 held by the metallic shell 5 projects its rear end portion 66 into the housing tube 3; thus, the reference electrode 62 formed on the inner surface of the closed-bottomed tubular detection element 6 is exposed to the air. As shown in FIG. 3, the four lead wires 18 are inserted through the four respective lead wire insertion holes 92.

As shown in FIGS. 2 and 3, the grommet 9 has four grooves 93 formed on its top surface 99, which faces rearward when the grommet 9 is attached to the gas sensor 1. The grooves 93 start from the aerial communication hole 91 and extend radially outward. The grooves 93 are disposed in such a manner that each of the grooves 93 passes between two adjacent lead wire insertion holes 92 so as to avoid the positions of the four lead wire insertion holes 92 which open at the top surface 99. Thus, the grooves 93 divide the top surface 99 into four sections.

As shown in FIG. 1, a filter member 87 and a metal retainer 88 for the filter member 87 are inserted into the aerial communication hole 91 of the grommet 9. The filter member 87 is, for example, a thin-film filter of micron-sized meshes made of fluororesin, such as PTFE (polytetrafluoroethylene), and allows the air to pass therethrough while repelling water droplets and the like. The metal retainer 88 is a tubular member for nipping the filter member 87 between the outer circumferential surface thereof and the inner circumferential surface of the aerial communication hole 91, thereby fixing the filter member 87 to the grommet 9. The grooves 93 of the grommet 9 serve as flow channels for leading, radially outward, water droplets and the like repelled by the filter member 87 so as to prevent them from stagnating on the filter member 87. The grooves 93 may slope frontward and radially outward from near the axis O.

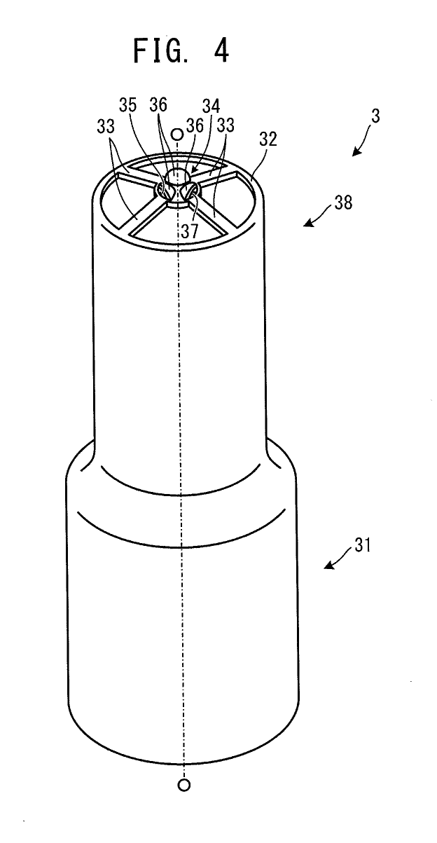

The housing tube 3 extending in the direction of the axis O is attached to a rear end portion of the metallic shell 5. As shown in FIG. 4, the housing tube 3 is formed in the following manner: stainless steel, such as SUS304, is formed into a tubular shape extending in the direction of the axis O while a larger diameter is imparted to a front portion 31 located frontward (downward in FIG. 4) of a substantially central portion with respect to the direction of the axis O. In order to engage the front portion 31 with the rear-end engagement portion 58 (see FIG. 1) of the metallic shell 5, the inside diameter of the front portion 31 is greater than the outside diameter of the rear-end engagement portion 58. Also, as shown in FIGS. 3 and 4, the rear end (an opening end 32) of a rear portion 38 of the housing tube 3 is bent radially inward, and four strip-like arm portions 33 project toward the axis O from four circumferential positions of the opening end 32. In the present embodiment, the four arm portions 33 slope frontward and radially outward from near the axis O.

The arm portions 33 are connected to the outer circumference of a disklike vent portion 34. As shown in FIG. 2, the vent portion 34 has substantially the same outside diameter as that of the aerial communication hole 91 of the grommet 9. As shown in FIGS. 1 and 3, the vent portion 34 is supported by the arm portions 33 in such a manner that its thickness direction coincides with the direction of the axis O and in such a manner as to cover the aerial communication hole 91. As shown in FIG. 4, the vent portion 34 has openings 35 extending therethrough in the thickness direction. Each of the openings 35 is smaller in size than the opening of the aerial communication hole 91 (see FIG. 1), thereby preventing entry of a flipped stone or the like into the aerial communication hole 91 through the openings 35. Furthermore, the vent portion 34 has covers 36 rising from the edges of the openings 35 in the thickness direction thereof so as to prevent entry of a flipped stone or the like into the openings 35 from the rear side with respect to the axis O. Also, each of the covers 36 has an opening 37 formed in its side, whereby aerial communication can be ensured through the openings 35 between the outside of the housing tube 3 and the inside of the aerial communication hole 91 (i.e., between the inside and the outside of the housing tube 3). The vent portion 34 is provided for protecting the filter member 87 disposed within the aerial communication hole 91 from an external impact, such as contact with plants or impingement of a flipped stone or the like, thereby preventing damage to the filter member 87.

As shown in FIG. 1, the housing tube 3 having the above-mentioned structure is disposed on the rear side of the metallic shell 5 while surrounding the circumference of the rear end portion 66 of the detection element 6, the separator 8, and the grommet 9, which are disposed in series in the direction of the axis O. The front end portion 31 of the housing tube 3 is externally fitted to the rear-end engagement portion 58 of the metallic shell 5 and is crimped radially inward from outside. Furthermore, the front end portion 31 is subjected to full-circle laser welding from outside, whereby the housing tube 3 is fixed to the metallic shell 5.

A portion of the housing tube 3 which corresponds to a portion of the separator 8 located frontward of the flange portion 81 is crimped radially inward along the entire circumference. The metal holder 85 is disposed at a position corresponding to the portion of the separator 8 located frontward of the flange portion 81. While holding the portion of the separator 8 therein, the metal holder 85 is held in the housing tube 3 through crimping. Also, a portion of the housing tube 3 which corresponds to a portion of the separator 8 located rearward of the flange portion 81 is crimped radially inward at a plurality of circumferential positions. This crimping work is performed in such a manner that the portion of the housing tube 3 comes into contact with the rear end of the flange portion 81, whereby the flange portion 81 is sandwiched between the metal holder 85 and the crimped portion of the housing tube 3. Thus, movement of the separator 8 in the direction of the axis O is restricted.

As shown in FIG. 1, the grommet 9 is disposed on the rear side of the separator 8 within the rear portion 38 of the housing tube 3. The four sections into which the top surface 99 is divided pass between the four arm portions 33 and project rearward from the housing tube 3. The arm portions 33 are disposed in the respective grooves 93. That is, the grommet 9 is held between the separator 8 and the arm portions 33, whereby movement of the grommet 9 in the direction of the axis O is restricted. Also, a side wall 39 of the housing tube 3 which surrounds the circumference of the grommet 9 disposed in the rear portion 38 of the housing tube 3 is crimped radially inward from outside, whereby a radial movement of the grommet 9 is restricted. Furthermore, as shown in FIG. 3, the arm portions 33 of the housing tube 3 are disposed in the respective grooves 93 of the grommet 9, whereby rotation of the grommet 9 about the axis O is restricted. Thus, the four lead wires 18 inserted through the four respective lead wire insertion holes 92 (see FIG. 3) of the grommet 9 are positioned relative to the housing tube 3 and do not come into contact with the arm portions 33, the vent portion 34, and the side wall 39 (particularly, the opening end 32). Therefore, the lead wires 18 can be reliably protected from damage which could otherwise result from contact with another member (the housing tube 3).

Since the arm portions 33 and the vent portion 34 are formed integral with the housing tube 3, there is eliminated a problem arising in the case where the housing tube 3 and the vent portion 34 are formed as separate members; specifically, a problem of an inclined assembly of the vent portion 34 to the housing tube 3 or a problem of generation of play of the vent portion 34 assembled to the housing tube 3. Thus, the vent portion 34 can reliably protect the filter member 87. Furthermore, there is no need to provide a structure of mutual fixation which is required in the case where the housing tube 3 and the vent portion 34 are formed as separate members, thereby not only reducing the number of components, but also simplifying the structure. Also, in the course of manufacture, there can be eliminated the number of man-hours associated with mutual fixation of the housing tube 3 and the vent portion 34.

Since the number of the arm portions 33 is two or greater (four in the first embodiment), support of the vent portion 34 by the arm portions 33 is enhanced, thereby ensuring positioning of the vent portion 34 relative to the side wall 39 of the housing tube 3. Thus, the generation of torsion of the vent portion 34 relative to the aerial insertion hole 91 can be prevented.

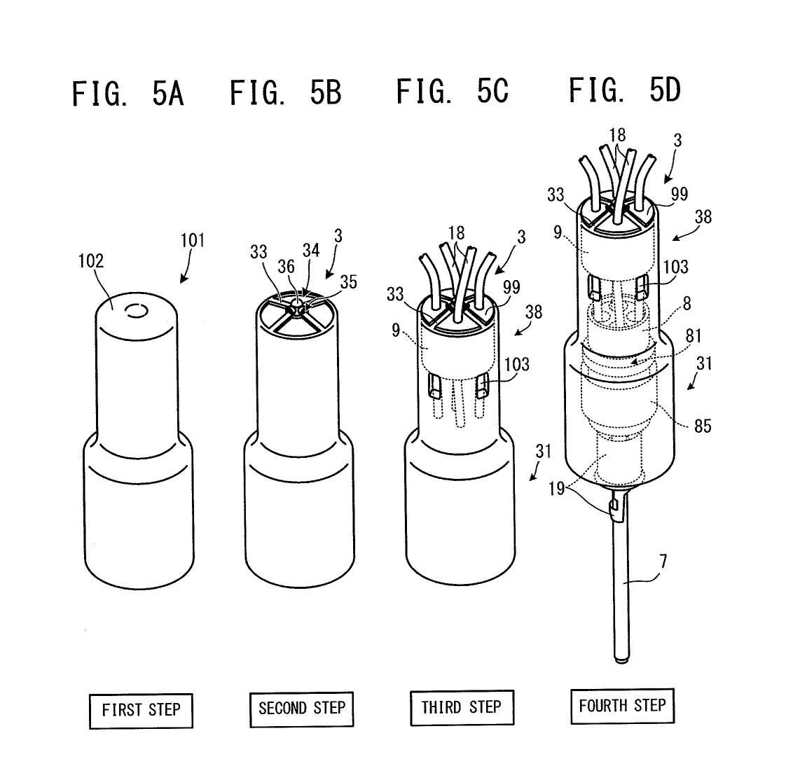

The thus configured gas sensor 1 may be manufactured, for example, by the following procedure. First, in the first step shown in FIG. 5A, a plate material of stainless steel, such as SUS304, is subjected to press working, thereby yielding a housing-tube intermediate 101 having a closed-bottomed tubular shape. Next, in the second step shown in FIG. 5B, a bottom 102 of the housing-tube intermediate 101 is subjected to stamping by use of a pressing machine, thereby yielding the housing tube 3 having the arm portions 33 and the vent portion 34. Furthermore, the vent portion 34 is subjected to press working, thereby forming the openings 35 and the covers 36 (also forming the openings 37 of the covers 36 shown in FIG. 4). The above-mentioned first and second steps may be performed simultaneously by means of a single stroke of press working.

Next, the filter member 87 and the metal holder 88 (see FIG. 1) are fitted into the aerial communication hole 91 of the grommet 9 formed in a separate step. Furthermore, the four lead wires 18 are inserted through the respective lead wire insertion holes 92 of the grommet 9 in such a manner as to project outward from the end of the grommet 9. The grommet 9 in this condition is accommodated in the housing tube 3. At this time, the four sections into which the top surface 99 of the grommet 9 is divided are caused to pass between the arm portions 33 and to be exposed from the rear end of the housing tube 3, and the arm portions 33 are disposed in the respective grooves 93 (see FIG. 1) of the grommet 9. By this procedure, the grommet 9 and the lead wires 18 are positioned relative to the housing tube 3.

In the third step shown in FIG. 5C, the rear portion 38 of the housing tube 3 is subjected to radially inward crimping conducted at circumferential intervals; i.e., at a plurality of circumferential positions (in the present embodiment, at four circumferential positions), thereby forming recesses (inward protrusions 103) projecting radially inward on the side wall 39 of the housing tube 3. The grommet 9 is caught by the inward protrusions 103; thus, in the course of assembly of the gas sensor 1, the grommet 9 is prevented from coming off from the rear portion 38 of the housing tube 3.

Furthermore, the lead wires 18 are inserted through the separator 8 and the metal holder 85, which have been formed in a separate step, in such a manner as to project outward therefrom. Subsequently, the distal ends of the lead wires 18 are joined to the four respective connection terminals 19 (see FIG. 1). Two of the connection terminals 19 are connected to the respective electrodes 71 of the heater 7. In the fourth step shown in FIG. 5D, the lead wires 18 in this condition are pulled rearward from the rear end of the housing tube 3, whereby the separator 8, the metal holder 85, and a rear end portion of the heater 7 are accommodated within the housing tube 3. By this procedure, there is completed a rear assembly of the gas sensor 1 in which the grommet 9, the separator 8, and a rear end portion of the heater 7 are held in the housing tube 3.

In a further step, there is formed a front assembly of the gas sensor 1 in which the detection element 6 is held in the metallic shell 5 shown in FIG. 1 and in which the protector 4 and the gasket 11 are attached to the metallic shell 5. The front assembly and the above-mentioned rear assembly are assembled together in such a manner that the front portion 31 of the housing tube 3 is fitted to the rear-end engagement portion 58 of the metallic shell 5. Then, the front portion 31 of the housing tube 3 is crimped radially inward to the rear-end engagement portion 58. Next, in a condition in which the flange portion 81 of the separator 8 is in contact with the inward protrusions 103 formed in the third step (see FIG. 5C), a side wall of the housing tube 3 which corresponds to the metal holder 85 is crimped radially inward. Furthermore, the side wall 39 of the housing tube 3 which corresponds to the grommet 9 is crimped radially inward. Subsequently, laser welding is performed, along the entire circumference, on a crimped region of the front portion 31 of the housing tube 3. Thus is completed the gas sensor 1.

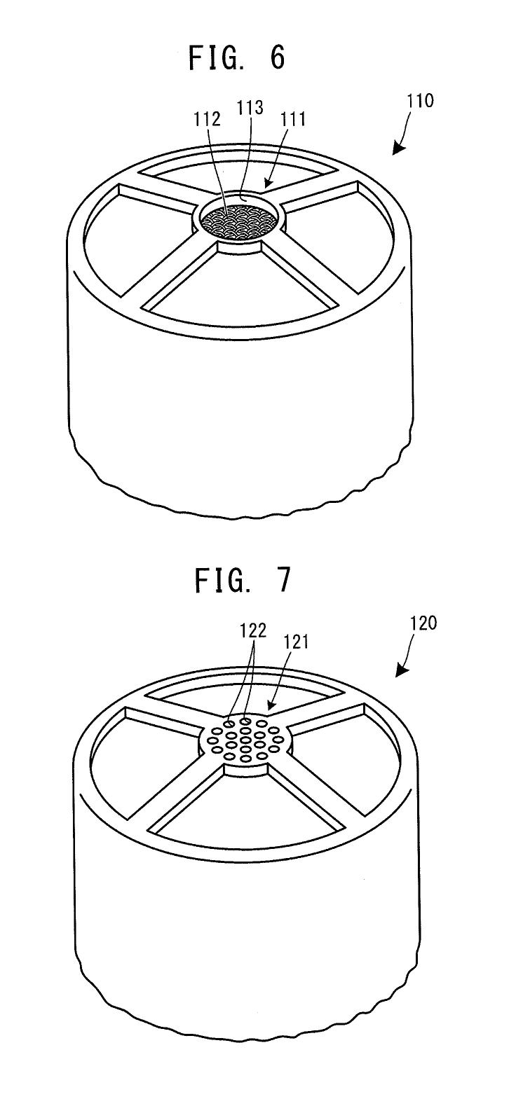

The first embodiment may be modified in various forms. For example, as in the case of a housing tube 110 shown in FIG. 6, a vent portion 111 may have an opening 112 greater in size than the openings 35 (see FIG. 1) of the first embodiment, and a mesh member 113 made of wire may be attached to the opening 112. The mesh member 113 can protect the filter member 87 from damage and can ensure aerial communication through the opening 112.

Also, as in the case of a housing tube 120 shown in FIG. 7, a vent portion 121 may have a plurality of holes 122. While aerial communication is ensured through the holes 122, the filter member 87 can be protected sufficiently from damage by means of an appropriate diameter being imparted to the holes 122 so as to avoid an external impact stemming from contact with plants or impingement of a flipped stone or the like. Of course, the number of the holes 122 can be varied as appropriate. By means of the number of holes 122 being increased to thereby increase the total area of openings of the holes 122, the vent portion 121 can ensure sufficient aerial communication.

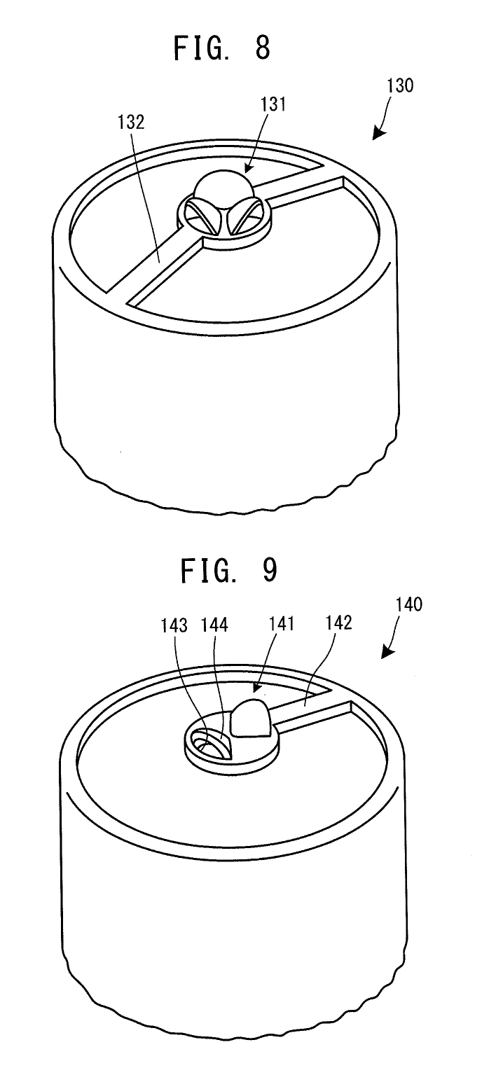

In the first embodiment, the number of arm portions 33 which support the vent portion 34 is four. However, as in the case of a housing tube 130 shown in FIG. 8, a vent portion 131 may be supported by two arm portions 132. Also, as in the case of a housing tube 140 shown in FIG. 9, a vent portion 141 may be supported by a single arm portion 142. Of course, the number of arm portions may be three, five, or greater. The number of grooves of the grommet may be varied according to the number of arm portions. Also, the number of grooves may be greater than the number of arm portions.

In the first embodiment, the vent portion 34 has three openings 35. However, the number of the openings 35 may be determined as appropriate. For example, in the housing tube 140 shown in FIG. 9, the vent portion 141 has two openings 143 and two covers 144 for the openings 143. However, the number of openings may be one or four or greater.

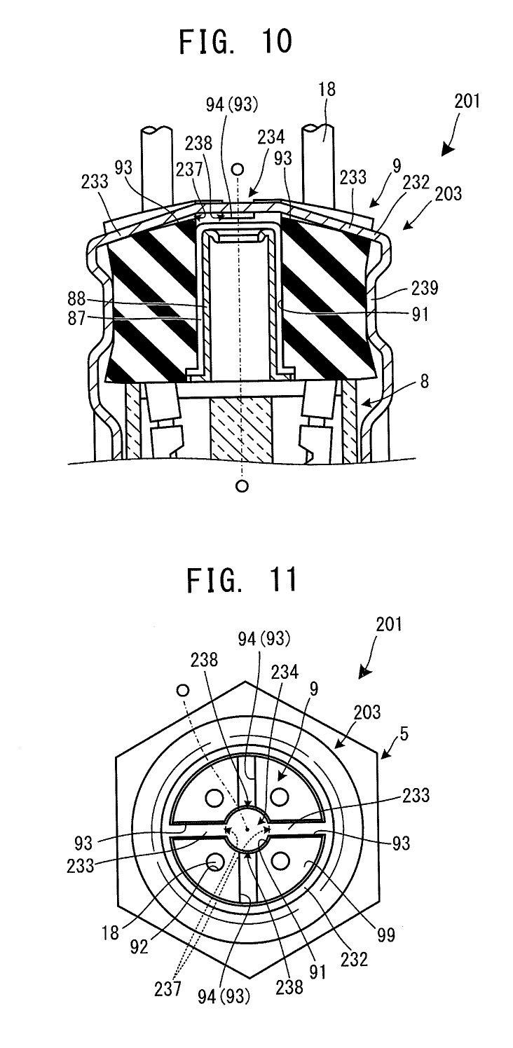

Next, a gas sensor 201 according to a second embodiment of the present invention will be described with reference to FIGS. 10 and 11. In the gas sensor 201 of the second embodiment, a housing tube 203 has a cover portion 234 which differs in form from the vent portion 34 (see FIG. 1) of the housing tube 3 of the gas sensor 1 of the first embodiment. That is, the gas sensor 201 uses the same components, except for the housing tube 203, as those of the gas sensor 1. Thus, the form of the housing tube 203 is described herein, and the description of other components is omitted or simplified.

Similar to the first embodiment, the housing tube 203 of the gas sensor 201 shown in FIG. 10 is formed into a closed-bottomed tubular shape from stainless steel, such as SUS304. The bottom of the closed-bottomed tubular shape is subjected to stamping, thereby forming arm portions 233 and the cover portion 234. As shown in FIGS. 10 and 11, the cover portion 234 has a disklike shape having substantially the same diameter as that of the aerial communication hole 91 of the grommet 9 and is supported by two arm portions 233 extending radially inward from an opening end 232 of a side wall 239 which surrounds the circumference of the grommet 9. The two arm portions 233 slope as do the arm portions 33 of the first embodiment. The roots of the arm portions 233 at the opening end 232 are located frontward of the arm portions 33 with respect to the direction of the axis O. The cover portion 234 does not have an opening.

In the thus-configured gas sensor 201, the cover portion 234 is disposed in such a manner as to cover the aerial communication hole 91. Thus, as shown in FIG. 11, when the gas sensor 201 is viewed from the rear side along the axis O, the filter member 87 is obscured by the cover portion 234 and is thus invisible. By virtue of this configuration, the filter member 87 is protected from contact with plants and impingement of a flipped stone or the like, thereby preventing damage to the filter member 87 which could otherwise be caused by an external impact.

The two arm portions 233 are disposed in the two corresponding ones of the four grooves 93 of the grommet 9. As shown in FIGS. 10 and 11, in the grooves 93 (for the sake of convenience, referred to as grooves 94) in which the respective arm portions 233 are not disposed, gaps 238 communicating with the inside of the aerial communication hole 91 are formed between the cover portion 234 and the grooves 94. Aerial communication is ensured through the gaps 238 between the outside of the housing tube 203 and the inside of the aerial communication hole 91 (i.e., between the inside and the outside of the housing tube 203). Of course, gaps 237 are formed between the cover portion 234 and the grooves 93 in which the respective arm portions 233 are disposed. Thus, aerial communication is possible through the gaps 237 between the outside of the housing tube 203 and the inside of the aerial communication hole 91.

Since the arm portions 233 and the cover portion 234 are formed integral with the housing tube 203, there is eliminated a problem potentially arising in the case where the housing tube 203 and the cover portion 234 are formed as separate members; specifically, a problem of an inclined assembly of the cover portion 234 to the housing tube 203 or a problem of generation of play of the cover portion 234 assembled to the housing tube 203. Thus, the cover portion 234 can reliably protect the filter member 87. Furthermore, there is no need to provide a structure of mutual fixation which is required in the case where the housing tube 203 and the cover portion 234 are formed as separate members, thereby not only reducing the number of components, but also simplifying the structure. Also, in the course of manufacture, there can be eliminated the number of man-hours associated with mutual fixation of the housing tube 203 and the cover portion 234.

Since the number of the arm portions 233 is two or greater (two in the second embodiment), support of the cover portion 234 by the arm portions 233 is enhanced, thereby ensuring positioning of the cover portion 234 relative to the housing tube 203. Thus, the generation of torsion of the cover portion 234 relative to the aerial insertion hole 91 can be prevented.

The second embodiment may also be modified in various forms. For example, as in the case of the above-mentioned housing tube 140 (see FIG. 9), only a single arm portion may be provided. Alternatively, the housing tube may have four arm portions, and the arm portions may be disposed in the four respective grooves 93 of the grommet 9. In this case, by means of the arm portions being rendered smaller in width than the grooves 93, introduction of the air into gaps between the arm portions and the grooves 93 can be ensured. Also, through the gaps 237 between the cover portion 234 and the grooves 93, aerial communication can be ensured between the outside of the housing tube and the inside of the aerial communication hole 91. Of course, the number of the arm portions of the housing tube and the number of the grooves of the grommet can be varied as appropriate.

Also, the grommet 9 may be subjected to machining so as to have, for example, cutouts leading to gaps between the arm portions 233 and the grooves 93, thereby ensuring aerial communication with the gaps through the cutouts. Also, aerial communication may be established between the outside of the housing tube and the inside of the aerial communication hole 91 through the gaps 237 between the cover portion 234 and the grooves 93.

In the first and second embodiments, the grooves 93 may not be formed in the grommet 9. In this case, at least a pair of protrusions may be provided on the top surface 99 of the grommet 9, and the arm portions 33 (233) of the housing tube may be disposed in such a manner as to pass between the protrusions. Alternatively, the grooves 93 may be formed partially; i.e., the grooves 93 connected to the aerial communication hole 91 may become shallower toward the outer circumference of the grommet 9 until the grooves 93 merge with the top surface 99.

### DESCRIPTION OF REFERENCE NUMERALS

1: gas sensor
3: housing tube
5: metallic shell
6: detection element
9: grommet
31: front end portion
33: arm portion
34: vent portion
35: opening
36: cover
37: opening
38: rear portion
39: side wall
64: detection portion
87: filter member
91: aerial communication hole
92: lead wire insertion hole
93: groove
111: vent portion
112: opening
113: mesh member
121: vent portion
122: hole
201: gas sensor
203: housing tube
233: arm portion
234: cover portion
237, 238: gap

1. A gas sensor comprising:
a detection element extending in a direction of an axis and having a detection portion located at its front end for detecting a particular gas;
a metallic shell allowing the detection portion to project from its front end and surrounding the circumference of the detection element;
a housing tube surrounding the circumference of a rear end portion of the detection element and fixed, at its front end portion, to the metallic shell; and
a plug member disposed in a rear end portion of the housing tube and having lead wire insertion holes which are formed therein in such a manner as to extend in the direction of the axis and through which respective lead wires extend for leading out detection signals from the detection element, and an aerial communication hole which is formed therein in such a manner as to extend in the direction of the axis and which can establish aerial communication between the inside and the outside of the housing tube via an intervening filter member having air permeability and waterproofness;
the gas sensor being characterized in that the housing tube has:
a side portion surrounding the circumference of the plug member;
a vent portion disposed rearward of the plug member, covering the aerial communication hole of the plug member, and having an opening smaller than at least an opening of the aerial communication hole; and
a strip-like arm portion extending radially and connecting the side portion and the vent portion to each other.

2. A gas sensor according to claim 1, wherein:
the plug member has, on its rear end surface, a groove starting from the aerial communication hole and extending radially outward in such a manner as to avoid the lead wire insertion holes, and
the arm portion is disposed in the groove.

3. A gas sensor according to claim 2, wherein:
the housing tube has at least two pieces of the arm portion, and the plug member has at least two pieces of the groove, and
the arm portions are disposed in the respective grooves.

4. A gas sensor according to claim 1, wherein the vent portion assumes a form in which a plurality of holes are formed therein in such a manner as to extend therethrough in the direction of the axis, a form in which a mesh member is attached to an opening thereof oriented in the direction of the axis, or a form in which a protrusion formed thereon has an opening formed in its side.

5. A gas sensor comprising:
a detection element extending in a direction of an axis and having a detection portion located at its front end for detecting a particular gas;
a metallic shell allowing the detection portion to project from its front end and surrounding the circumference of the detection element;
a housing tube surrounding the circumference of a rear end portion of the detection element and fixed, at its front end portion, to the metallic shell; and
a plug member disposed in a rear end portion of the housing tube and having lead wire insertion holes which are formed therein in such a manner as to extend in the direction of the axis and through which respective lead wires extend for leading out detection signals from the detection element, and an aerial communication hole which is formed therein in such a manner as to extend in the direction of the axis and can establish aerial communication between the inside and the outside of the housing tube via an intervening filter member having air permeability and waterproofness;
the gas sensor being characterized in that the housing tube has:
a side portion surrounding the circumference of the plug member;
a cover portion which covers the filter member in such a manner that, as viewed from a rear side of the gas sensor in the direction of the axis, the filter member is invisible and which allows aerial communication between the inside of the aerial communication hole and the outside of the housing tube via a gap between the cover portion and the plug member; and
a strip-like arm portion extending radially and connecting the side portion and the cover portion to each other.

6. A gas sensor according to claim 5, wherein:
the plug member has, on its rear end surface, a groove starting from the aerial communication hole and extending radially outward in such a manner as to avoid the lead wire insertion holes, and
the arm portion is disposed in the groove.

7. A gas sensor according to claim 6, wherein:
the housing tube has at least two pieces of the arm portion, and the plug member has at least two pieces of the groove, and
the arm portions are disposed in the respective grooves.
